(19) United States
(12) Patent Application Publication
(10) Pub. No.: US 2010/0233486 A1
(43) Pub. Date: Sep. 16, 2010

(54) FLAME-RETARDANT RESIN COMPOSITION, AND PREPREG, RESIN SHEET AND MOLDED ARTICLE USING THE SAME

(76) Inventors: Hiroharu Inoue, Hirakata-shi (JP); Keiko Kashihara, Ibaraki-shi (JP); Kenji Ogasawara, Hirakata-shi (JP)

Correspondence Address: Cheng Law Group, PLLC, 1100 17th Street, N.W., Suite 503, Washington, DC, 20036, US

(21) Appl. No.: 12/279,697

(22) PCT Filed: Feb. 7, 2007
(86) PCT No.: PCT/JP2007/052100

§ 371 Date: Aug. 15, 2008

(30) Foreign Application Priority Data
Feb. 23, 2006 (JP) 2006-047471

(51) Int. Cl. B32B 27/38; C08K 5/5399

(52) U.S. Cl. 428/417; 524/100; 524/86; 428/418

(57) ABSTRACT

There is provided a flame-retardant resin composition which can maintain heat resistance at a high level and simultaneously provide low dielectric constant and low dielectric loss tangent while ensuring flame-retardancy without containing any halogen compound causing the generation of harmful substances. This flame-retardant resin composition comprises 0.1 to 200 parts by mass of a cyclophosphazene compound represented by the following formula (1):

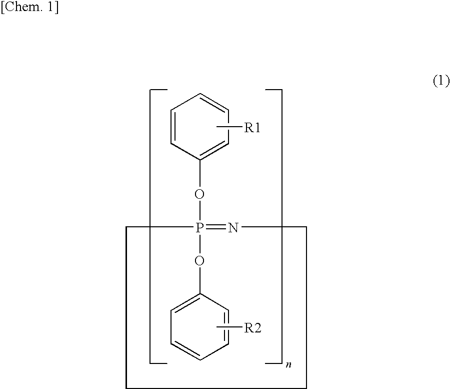

wherein n=3 to 25; and one of R1 and R2 is CN and the other is H, or both of R1 and R2 are CN, based on 100 parts by mass of a resin component containing a polyfunctional epoxy resin having a biphenyl aralkyl structure, wherein the ratio of cyanophenoxy groups in the compound is 2 to 98% of the total number of phenoxy groups and cyanophenoxy groups in the compound.

### TECHNICAL FIELD

The present invention relates to a flame-retardant resin composition suitable for the production of printed wiring boards and for sealing semiconductor devices, a prepreg and a resin sheet which are produced using the composition, and to a molded article such as a printed wiring board produced using the composition, and a molded article obtained by sealing a semiconductor device with the composition.

### BACKGROUND ART

Flame-retardancy is required for a molded article such as a printed wiring board and a molded article obtained by sealing a semiconductor device to ensure safety. Although this flame-retardancy can be achieved by using a resin composition containing a halogen compound, the molded article formed of such a resin composition generates harmful dioxins during incineration, and therefore is perceived as a problem from the viewpoint of environmental protection in recent years.

Therefore, it has been proposed in Japanese Patent Application Laid-Open No. 10-259292, 11-181429 or 2002-114981 that a compound mainly containing nitrogen or phosphor is blended into a resin composition as a flame retardant to achieve flame-retardancy without using a halogen compound.

However, these resin compositions containing a flame retardant are compatible systems and therefore may cause a problem, for example, that the presence of a flame retardant reduces the glass-transition temperature (Tg) of a resin after molding to impair the heat resistance of a molded article. As described above, although flame-retardancy can be achieved without using a halogen compound, such a type of a flame retardant—containing resin composition still has left room for improvement.

### DISCLOSURE OF THE INVENTION

Therefore, the present invention has been made in view of the above problems, and its object is to provide a flame-retardant resin composition which can maintain heat resistance at a high level and simultaneously provide low dielectric constant and low dielectric loss tangent while ensuring flame-retardancy without containing any halogen compound causing the generation of harmful substances.

That is, the flame-retardant resin composition in accordance with this invention comprises 100 parts by mass of a resin component containing a polyfunctional epoxy resin having a biphenyl aralkyl structure and 0.1 to 200 parts by mass of cyclophosphazene compound represented by the following formula (1).

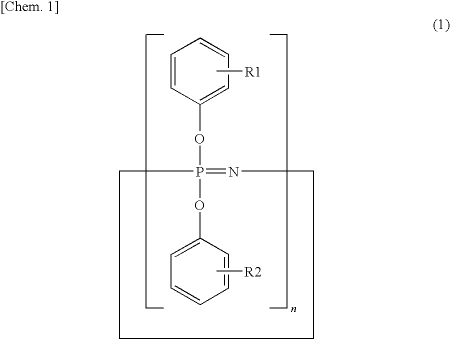

wherein n=3 to 25; and one of R1 and R2 is CN and the other is H, or both of R1 and R2 are CN, wherein the ratio of cyanophenoxy groups in the compound is 2 to 98% of the total number of phenoxy groups and cyanophenoxy groups in the compound.

According to the present invention, the flame-retardant resin composition can maintain heat resistance at a high level while ensuring flame-retardancy by a predetermined cyclophosphazene compound without using a halogen compound causing the generation of harmful substances. In addition, the flame-retardant resin composition can provide low dielectric constant and low dielectric loss tangent, and therefore is particularly suitable for the use of recent electronic equipments which require speeding up of information processing.

Further, it is preferred that the above flame-retardant resin composition further contains an inorganic filler. In this case, the improvement of the strength of a molded article and further improvement of the flame-retardancy can be achieved.

Further, the above resin component preferably contains polyfunctional epoxy resin having a biphenyl aralkyl structure, and at least one selected from an epoxy resin, a radical polymerizable resin, a polyimide resin, a polyphenylene ether resin, a thermoplastic polyimide resin, a polyetherimide resin, a polyethersulfone resin, a phenoxy resin and modified resins thereof. In this case, the Tg of a resin can be increased to provide heat resistance at a high level. Particularly, when a polyphenylene ether resin or a terminal-modified polyphenylene ether resin is used, the dielectric constant and dielectric loss tangent can be further lowered.

Another object of the present invention is to provide a prepreg obtained by impregnating a glass substrate or an organic fiber substrate with the above flame-retardant resin composition, and drying it.

Other object of the present invention is to provide a resin sheet obtained by applying the above flame-retardant resin composition onto the surface of a metal foil or film, and drying it.

Still another object of the present invention is to provide a molded article obtained by molding the above flame-retardant resin composition.

The further characteristics and effects of the present invention will be clearly understood by the best modes for carrying out the invention described below.

### BEST MODES FOR CARRYING OUT THE INVENTION

Hereinafter, the flame-retardant resin composition of the present invention, and a prepreg, a resin sheet and a molded product containing the composition will be specifically described based on preferred embodiments.

The flame-retardant resin composition according to the present invention is characterized by comprising a resin component containing a polyfunctional epoxy resin having a biphenyl aralkyl structure (hereinafter, referred to as “biphenyl aralkyl-type polyfunctional epoxy resin”), and a cyclophosphazene compound represented by the following formula (1) (hereinafter, referred to as “cyclophosphazene compound of the formula (1)”), wherein the amount of a cyclophosphazene compound of the formula (1) is 0.1 to 200 parts by mass based on 100 parts by mass of the resin component. When the amount of a cyclophosphazene compound of the formula (1) is less than 0.1 parts by mass based on 100 parts by mass of the resin component, the flame-retardancy cannot be sufficiently ensured. On the contrary, when it is more than 200 parts by mass, the resin amount relatively runs short to reduce molding processability. It is to be noted that a cyclophosphazene compound of the formula (1) is used as a flame retardant in the present invention, but other flame retardants such as aluminum hydroxide and silicon dioxide (SiO₂) may be used in combination as long as the effect is not impaired.

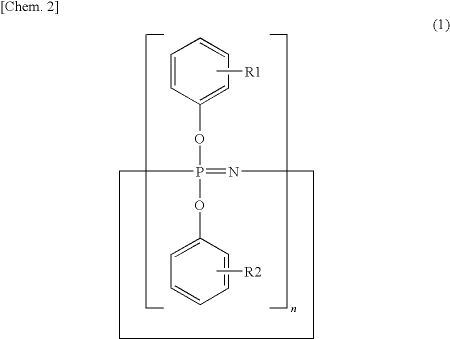

wherein n=3 to 25; and one of R1 and R2 is CN and the other is H, or both of R1 and R2 are CN. In addition, the ratio of cyanophenoxy groups in the above compound is 2 to 98% of the total number of phenoxy groups and cyanophenoxy groups in the above compound.

The term “cyanophenoxy group” in the above formula (1) refers to a functional group represented by the following formula (2), and the term “phenoxy group” refers to a functional group represented by the following formula (3). Even when the ratio of cyanophenoxy groups in a cyclophosphazene compound of the formula (1) is less than 2%, and on the contrary, even when it is more than 98%, both high flame-retardancy and glass transition temperature (Tg) cannot be satisfied.

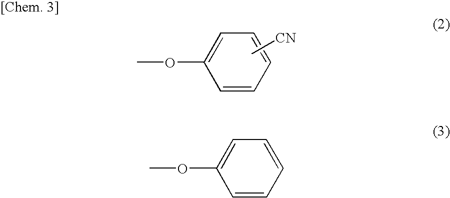

Examples of the cyclophosphazene compound of the formula (1) include the compounds represented by the following formulas (4) to (7).

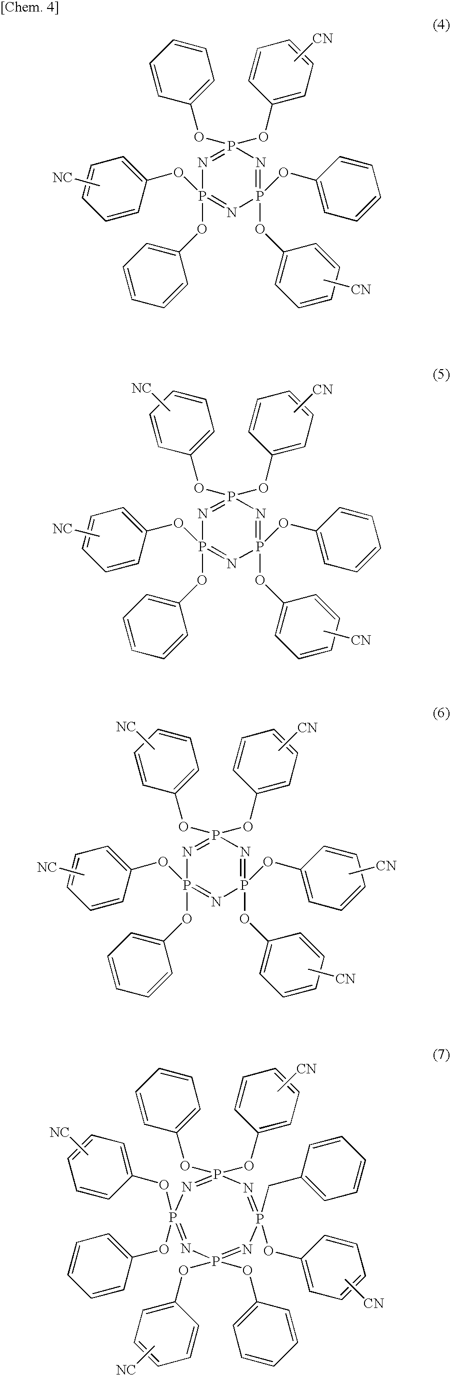

Alternatively, as a cyclophosphazene compound of the formula (1), for example, the compound synthesized by the method described in the Japanese Patent Application Laid-Open No. 2002-114981 may be used.

The ratio of cyanophenoxy groups can be calculated by substituting the number of moles of each of cyanophenol and phenol charged when synthesizing a cyclophosphazene compound of the formula (1) to the following formula. Ratio of cyanophenoxy groups (%)=(Number of moles of cyanophenol)/(Number of moles of cyanophenol+Number of moles of phenol)×100

It is to be noted that no phenoxy group is present in the cyclophosphazene compound represented by the following formula (8), and only a cyanophenoxy group, except an N atom, is attached to a P atom, and therefore the ratio of cyanophenoxy groups is 100%, so that flame-retardancy cannot be sufficiently ensured as described above.

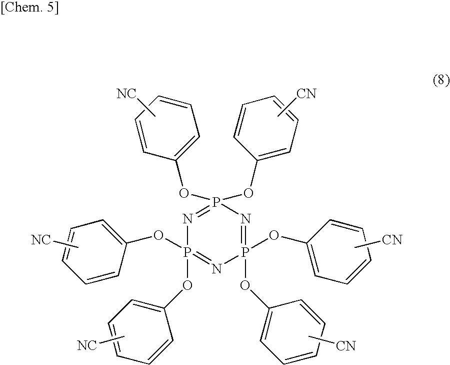

Meanwhile, in the present invention, a cyclophosphazene compound of the formula (1) is blended in an amount of 0.1 to 200 parts by mass based on 100 parts by mass of a biphenyl aralkyl-type polyfunctional epoxy resin used as a resin component, and thereby low dielectric constant and low dielectric loss tangent can be achieved, but a biphenyl aralkyl-type polyfunctional epoxy resin and one or two or more other resins are also preferably used as resin components. In this case, a cyclophosphazene compound of the formula (1) is blended in an amount of 0.1 to 200 parts by mass based on 100 parts by mass of the total of a biphenyl aralkyl-type polyfunctional epoxy resin and the other resin(s). It is to be noted that when one or two or more resins other than a biphenyl aralkyl-type polyfunctional epoxy resin are blended, the amount of a biphenyl aralkyl-type polyfunctional epoxy resin is preferably 30 parts by mass or more, more preferably 40 parts by mass or more, and particularly preferably 50 parts by mass or more, based on 100 parts by mass of the total of the biphenyl aralkyl-type polyfunctional epoxy resin and the other resin(s).

As a resin other than the biphenyl aralkyl-type polyfunctional epoxy resin, a thermosetting resin or a thermoplastic resin can be used. As the thermosetting resin, for example, a polyfunctional epoxy resin, an ortho-cresol novolac epoxy resin, a bisphenol A (Bis-A)-type epoxy resin and a bismaleimide resin can be used. In order to further improve heat resistance by increasing the Tg, at least one selected from the group consisting of an epoxy resin, a radical polymerizable resin, a polyimide resin and modified resins thereof is preferably used. Specific examples of the epoxy resin include polyfunctional epoxy resins such as a triphenylmethane-type polyfunctional epoxy resin, an ortho-cresol novolac epoxy resin and a bisphenol A (Bis-A)-type epoxy resin, and specific examples of the radical polymerizable resin include methacrylated products or acrylated products, and acrylates of the above epoxy resins, and specific examples of the polyimide resin include a bismaleimide resin.

As the thermoplastic resin, for example, an OH-modified polyphenylene ether resin (OH-modified PPE), a modified polyphenylene ether resin (modified PPE), a phenoxy resin, a polyethersulfone resin (PES), a polyphenylene ether resin (PPE), a polyimide resin and a styrene-based polymer having a syndiotactic structure (SPS) can be used. In order to further improve heat resistance by increasing the Tg, at least one selected from the group consisting of a polyphenylene ether resin (PPE), a thermoplastic polyimide resin, a polyetherimide resin, a polyethersulfone resin (PES), a phenoxy resin and modified resins thereof is preferably used. Specific examples of the modified resin of a polyphenylene ether resin (PPE) include an OH-modified polyphenylene ether resin (OH-modified PPE). Particularly, when a polyphenyl ether resin represented by the following formula (9), or a terminal-modified polyphenyl ether resin in which at least one of R7 and R8 is substituted with at least one of unsaturated groups represented by the following formulas (10) and (11) in the following formulas (9) is used, high heat resistance can be obtained, and additionally the dielectric constant and dielectric loss tangent can be further reduced.

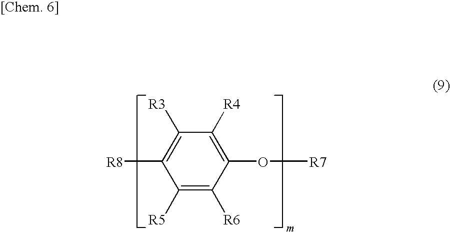

wherein m=10 to 300; R3 to R6 are each any one of H and CₙH₂ₙ₊₁ (n=1 to 10); R7 is any one of H and a group containing an unsaturated carbon-carbon bond; R8 is any one of H, OH and a group containing an unsaturated carbon-carbon bond; and at least one of R7 and R8 is a group containing an unsaturated carbon-carbon bond.

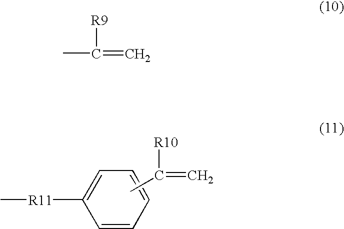

wherein R9 to R11 are each H or a hydrocarbon group having 1 to 10 carbon atoms.

A curing agent or catalyst may be blended into the flame-retardant resin composition according to the present invention, as required. As the curing agent or catalyst, for example, dicyandiamide (DICY), phenol novolac, diaminodiphenylmethane (DDM), 2-ethyl-4-methylimidazole (2E4MZ), cumene hydroperoxide (CHP), α-α′-bis(t-butylperoxy-m-isopropyl)benzene and triphenylphosphine can be used.

Further, an inorganic filler may be added to the flame-retardant resin composition according to the present invention from the viewpoint of improving the strength of a molded article and further improving the flame-retardancy. As the inorganic filler, for example, titania (TiO₂) and calcium carbonate (CaCO₃) can be used. Such an inorganic filler can be blended in an amount of 0.1 to 200 parts by mass based on 100 parts by mass of a resin component. It is to be noted that when the resin component contains only biphenyl aralkyl-type polyfunctional epoxy resin, an inorganic filler may be blended in an amount of 0.1 to 200 parts by mass based on 100 parts by mass of a biphenyl aralkyl-type polyfunctional epoxy resin.

Furthermore, the flame-retardant resin composition according to the present invention may contain “CTBN” produced by UBE INDUSTRIES LTD. which is terminal carboxyl group-modified liquid polybutadiene rubber, a coupling agent such as γ-glycidoxypropyltriethoxysilane, a release agent such as carnauba wax, and the like, other than an inorganic filler.

The flame-retardant resin composition according to the present invention can be produced by blending so that a resin component containing a biphenyl aralkyl-type polyfunctional epoxy resin and a cyclophosphazene compound of the formula (1) are within the above range, and adding other resin, an inorganic filler and the like as required.

For example, a prepreg using the flame-retardant resin composition according to the present invention can be produced as follows. Firstly, the above described flame-retardant resin composition is dissolved in a solvent such as dimethylacetamide, dimethylformamide (DMF), N-methylpyrrolidone, dimethylsulfoxide, methyl ethyl ketone (MEK), cyclohexanone, toluene or xylene to prepare a varnish. Next, a glass substrate or a substrate of an organic fiber such as an aramid fiber, a polyester fiber, a polyimide fiber or a polyacrylic fiber was impregnated with the obtained varnish, and then the resulting substrate was dried until it reached a B-stage semicured state. The thus obtained prepreg is particularly suitable as a material of a printed wiring board.

Further, a resin sheet using the flame-retardant resin composition according to the present invention can be produced as follows. That is, a varnish obtained in the same manner as the above was applied onto the surface of a metal foil or film, and then dried until it reached a B-stage semicured state. The thus obtained resin sheet is also suitable as a material of a printed wiring board. It is to be noted that when a varnish is applied to a metal foil, a resin sheet with a metal foil can be obtained, and when a varnish is applied to a film, a resin sheet with a film can be obtained. Here, as a metal foil, for example, a copper foil and an aluminum foil can be used, and as a film, for example, a fluororesin film and a PET film can be used.

Furthermore, the above flame-retardant resin composition can be formed into a desired shape to provide a molded article which is excellent in heat resistance and has low dielectric constant and low dielectric loss tangent. For example, a semiconductor device is subjected to encapsulation molding using the above flame-retardant resin composition as a sealing material, and thereby a semiconductor equipment made of a molded article can be obtained.

As one of important technical ideas of the present invention, the flame-retardant resin composition is not a compatible-system, but a non-compatible system, and therefore the characteristics intrinsic to a resin are not impaired by a cyclophosphazene compound of the formula (1) after molding. Specifically, the reduction in Tg can be prevented by using the cyclophosphazene compound of the formula (1), and can improve the heat resistance of a molded article which is produced by such a flame-retardant resin composition. Further, since the molded article does not contain any halogen compound, even when it is burned out, harmful substances such as dioxins are not generated, so that the detoxification can be achieved. Furthermore, recent electronic equipments using high frequency band such as mobile communication is expected to reduce loss during transmission. The present invention realizes low dielectric constant and low dielectric loss tangent by using a biphenyl aralkyl-type polyfunctional epoxy resin, and therefore can also respond to the request of loss reduction during transmission.

### EXAMPLES

Hereinafter, the present invention will be specifically described by means of examples.

As a thermosetting resin used for a resin component, a polyfunctional epoxy resin (1) (“NC-3000” produced by NIPPON KAYAKU CO., LTD.) or a polyfunctional epoxy resin (2) (VG-3101L″ produced by Mitsui Chemicals, Inc.) was used. The polyfunctional epoxy resin (1) is a biphenyl aralkyl-type polyfunctional epoxy resin.

As a thermoplastic resin used for a resin component, an OH-modified PPE-1 or a modified PPE was used. The OH-modified PPE-1 was prepared as follows. That is, 100 parts by mass of a polymer PPE (“640-111”; number average molecular weight Mn=20000, produced by NIPPON G.E. PLASTIC CO., LTD.), 5 parts by mass of benzoyl peroxide and 6 parts by mass of bisphenol A were added to 100 parts by mass of toluene, and the mixture was stirred at 90° C. for 60 minutes and subjected to redistribution reaction to thereby obtain an OH-modified PPE-1 solution. The molecular distribution of OH-modified PPE-1 in this solution was measured by gel permeation chromatography (GPC) (column constitution: “superHM-M” (one column)+“superHM-H” (one column) manufactured by TOSOH CORPORATION), so that the number average molecular weight of OH-modified PPE-1 was 2300.

On the other hand, a modified PPE was prepared as follows. Firstly, 36 parts by mass of PPE (“NORYL PX9701”: number average molecular weight Mn=14000, produced by NIPPON GE. PLASTIC CO., LTD.), 0.77 parts by mass of 2,6-xylenol which is a phenol species, 1.06 parts by mass of t-butylperoxyisopropyl monocarbonate (“PERBUTYL I” produced by NOF CORPORATION) which is an initiator and 0.0015 parts by mass of cobalt naphthenate were blended, and 90 parts by mass of toluene which is a solvent was added thereto, and the mixture was mixed at 80° C. for 1 hour to disperse and dissolve them in toluene, thereby performing a reaction to obtain a PPE solution. The molecular distribution of PPE in this solution was measured by the above gel permeation chromatography (GPC), so that the number average molecular weight of PPE was about 3500. Then the PPE solution was dried under reduced pressure at 70° C., and thereby toluene, which is a solvent, was removed until the content reaches 1% by mass or less. Next, an allyl group (CH₂═CH—CH₂—) which is a carbon-carbon unsaturated group was introduced into a molecule of PPE which was converted into a lower molecular weight resin as described above. Specifically, 350 g of the PPE was weighed and dissolved in 7 L of tetrahydrofuran, and 390 ml of a hexane solution of n-butyllithium (1.5 mol/L) was further added to the resulting solution, and the mixture was stirred at 40° C. for 1 hour under a nitrogen atmosphere to perform a reaction. To this reactant was added 30 ml of allyl bromide, and the mixture was stirred still at 40° C. for additional 30 minutes. A mixed solution of 3 L of water and 3 L of methanol was added to this mixture to precipitate a polymer. Then, after repeating filtration and methanol wash 5 times, the polymer was dried under vacuum at 50° C. for 24 hours to obtain a modified PPE which is a PPE having an allyl group.

As a flame retardant, non-compatible-type phosphazene 1 containing cyanophenoxy groups (corresponding to Synthesis Example 1 in the following “Table 1”), compatible-type phosphazene (“SPB100” produced by OTSUKA Chemical Co., Ltd.), aluminum hydroxide or silicon dioxide (SiO₂) was used.

Further, the synthesis method of non-compatible-type phosphazene 1 containing cyanophenoxy groups is as follows. That is, to a 2 L-capacity four-neck flask equipped with a stirrer, a heater, a thermometer and a dehydrator were added 1.76 mol of 4-cyanophenol, 0.88 mol of phenol, 2.64 mol of sodium hydroxide and 1000 ml of toluene. Next, this mixture was heated and refluxed to remove water from the system, and thereby a toluene solution of sodium salts of cyanophenol and phenol was prepared. Then, 580 g of a 20% chlorobenzene solution containing 1 mol of dichlorophosphazene oligomer 1 (containing 95% or more of a trimer) was added dropwise to the toluene solution of sodium salts of cyanophenol and phenol at an inner temperature of 30° C. or less while stirring. After this mixed solution was refluxed for 12 hours, a 5% aqueous sodium hydroxide solution was added to the reaction mixture and the mixture was washed twice. Successively, the organic layer was neutralized with diluted sulfuric acid, and then washed with water twice. The organic layer was filtered, concentrated and dried under vacuum (vacuum drying condition: 80° C., 5 mmHg, 12 hours) to give non-compatible-type phosphazene 1 containing cyanophenoxy groups (Synthesis Example 1). This product was confirmed to be “N═P(OC₆H₄CN)_{1.34}(OC₆H₅)_{0.66}” from elemental analysis.

TABLE 1

| | Synthesis |
|---|---|
| | Example 1 |
| Dichlorophosphazene oligomer 1 (*), mass (mole) | 115.9 (1) |
| 4-cyanophenol, mass (mole) | 209.6 (1.76) |
| Phenol, mass (mole) | 82.8 (0.88) |
| Ratio of cyanophenol group | 67% |

(*) Containing 95% or more of a trimer

### 2-Ethyl-4-methylimidazole (2E4MZ) (produced by SHIKOKU CHEMICALS CORPORATION) was used as a catalyst

Each component was blended in a blending amount (part by mass) shown in Table 2, and the resulting mixture was diluted with toluene so that the solid content becomes 50% by mass, and thereby a varnish for impregnation was obtained. The term “solid content” as used herein means components other than solvents. Here, the varnish for impregnation was mixed at about 1000 rpm for about 90 minutes with “Homodisperser” manufactured by TOKUSHU KIKA KOGYO CO., LTD.

A laminate (CCL) was produced as a sample for evaluation. Specifically, a glass cloth (unit weight: 107 g/m², thickness: 0.1 mm) was first impregnated with the above varnish for impregnation and dried to produce a prepreg (resin amount: 40% by mass). Then, 8 sheets of this prepreg were laminated, and 18 m-thick copper foils were each laminated on the front and rear surfaces of the obtained laminate. The resulting laminate was heated and pressed in the curing conditions of a temperature of 200° C., a pressure of 3 MPa and a time period of 120 minutes for laminate molding, and thereby a double-side copper clad laminate (CCL) was produced.

The flame-retardancy (FR property), glass transition temperature (Tg) and dielectric constant characteristic (Dk, Df) were measured using the obtained sample for evaluation. The measurement results are shown in Table 2. Here, in the evaluation of flame-retardancy (FR property), a test piece with a length of 125 mm and a width of 13 mm was cut out from the evaluation sample (CCL), and a fire behaviour test was conducted for this test piece in accordance with the “Test for Flammability of Plastic Materials-UL94” of Underwriters Laboratories. Further, the glass transition temperature (Tg) was measured using a viscoelastic spectrometer “DMS100” manufactured by Seiko Instruments Inc. At that time, the glass transition temperature was measured at a frequency of 10 Hz by a bending module, a temperature in which tan δ shows the maximum value when the test piece was heated from room temperature to 280° C. in the condition of a rate of temperature increase of 5° C./min was taken as a glass transition temperature (Tg). In addition, the dielectric constant characteristic (Dk, Df) was determined by the method as specified in JIS C 6481.

TABLE 2

| | | | | | | | | | Compar- | Compar- | Compar- |
|---|---|---|---|---|---|---|---|---|---|---|---|
| | | | | | | | | | ative | ative | ative |
| | | Example 1 | Example 2 | Example 3 | Example 4 | Example 5 | Example 6 | Example 7 | Example 1 | Example 2 | Example 3 |
| Resin | OH-modified | 50 | 50 | | 50 | 50 | 50 | 50 | 50 | 50 | |
| | PPE-1 | | | | | | | | | | |
| | Modified PPE | | | 50 | | | | | | | 50 |
| | Polyfunctional | 50 | 50 | 50 | 50 | 50 | 50 | 50 | 50 | | |
| | epoxy resin (1) | | | | | | | | | | |
| | Polyfunctional | | | | | | | | | 50 | 50 |
| | epoxy resin (2) | | | | | | | | | | |
| Catalyst | 2E4MZ | 0.1 | 0.1 | 0.1 | 0.1 | 0.1 | 0.1 | 0.1 | 0.1 | 0.1 | |
| Flame | Synthesis | 20 | 10 | 20 | 20 | 20 | 20 | 20 | | 20 | 20 |
| retardant | Example 1 | | | | | | | | | | |
| | Compatible-type | | 10 | | | | | | 24 | | |
| | phosphazene | | | | | | | | | | |
| | Aluminum | | | | 10 | 50 | | 50 | | | |
| | hydroxide SiO₂ | | | | | | 30 | 30 | | | |
| Items | Evaluation | CCL | CCL | CCL | CCL | CCL | CCL | CCL | CCL | CCL | CCL |
| | sample | | | | | | | | | | |
| | Flame retardancy | V-O | V-O | V-O | V-O | V-O | V-O | V-O | V-O | V-O | V-O |
| | (FR property) | | | | | | | | | | |
| | Glass transition | 187 | 183 | 185 | 185 | 183 | 186 | 183 | 156 | 185 | 185 |
| | temperature (Tg) | | | | | | | | | | |
| | Dk (1 MHz) | 4.08 | 4.19 | 4.13 | 4.16 | 4.35 | 4.00 | 4.35 | 4.32 | 4.35 | 4.38 |
| | Df (1 MHz) | 0.0031 | 0.0039 | 0.0035 | 0.0035 | 0.0036 | 0.0031 | 0.0038 | 0.0039 | 0.0052 | 0.0055 |

As can be seen from the results of Table 2, in Comparative Example 1 in which compatible-type phosphazene was used as a flame retardant, low dielectric constant and low dielectric loss tangent can be achieved, but the glass transition temperature was low, and therefore there is a problem with the heat resistance. On the other hand, in Comparative Examples 2 and 3 in which the polyfunctional epoxy resin (2) different from the polyfunctional epoxy resin (1) of the present invention was used, although the glass transition temperature was high and the dielectric constant was low, the dielectric loss tangent tends to increase (be poor). On the contrary, in Examples 1 to 7, low dielectric constant and low dielectric loss tangent can be obtained, and simultaneously the glass transition temperature is high and therefore the heat resistance is also excellent.

### INDUSTRIAL APPLICABILITY

As described above, the flame-retardant resin composition according to the present invention can maintain heat resistance at a high level while ensuring flame-retardancy by a predetermined cyclophosphazene compound without using a halogen compound causing the generation of harmful substances. Further, the flame-retardant resin composition can realize low dielectric constant and low dielectric loss tangent, and therefore is expected for application to, for example, electronic equipments which require speeding up of information processing.

1. Aflame-retardant resin composition comprising:
100 parts by mass of a resin component containing a polyfunctional epoxy resin having a biphenyl aralkyl structure; and
0.1 to 200 parts by mass of cyclophosphazene compound represented by the following formula (1): 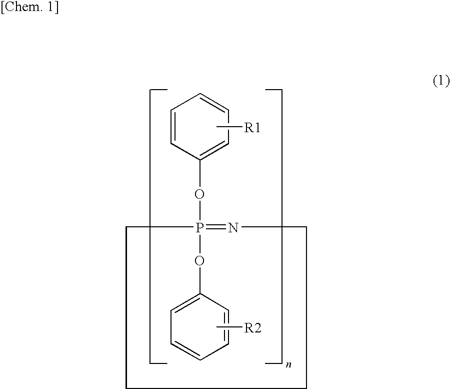
wherein n=3 to 25; and one of R1 and R2 is CN and the other is H, or both of R1 and R2 are CN, wherein the ratio of cyanophenoxy groups in the compound is 2 to 98% of the total number of phenoxy groups and cyanophenoxy groups in the compound.

2. The flame-retardant resin composition according to claim 1, comprising 0.1 to 200 parts by mass of the cyclophosphazene compound based on 100 parts by mass of a polyfunctional epoxy resin having a biphenyl aralkyl structure as the resin component.

3. The flame-retardant resin composition according to claim 1, further comprising an inorganic filler.

4. The flame-retardant resin composition according to claim 1, wherein the resin component contains a polyfunctional epoxy resin having a biphenyl aralkyl structure, and at least one selected from an epoxy resin, a radical polymerizable resin, a polyimide resin, a polyphenylene ether resin, a thermoplastic polyimide resin, a polyetherimide resin, a polyethersulfone resin, a phenoxy resin and modified resins thereof.

5. A prepreg obtained by impregnating a glass substrate or an organic fiber substrate with the flame-retardant resin composition according to claim 1, and drying it.

6. A resin sheet obtained by applying the flame-retardant resin composition according to claim 1 onto the surface of a metal foil or film, and drying it.

7. A molded article obtained by molding the flame-retardant resin composition according to claim 1.
